(19) United States
(12) Patent Application Publication
(10) Pub. No.: US 2018/0241911 A1
(43) Pub. Date: Aug. 23, 2018

(54) IMAGE FORMING APPARATUS AND IMAGE FORMATION CONTROL PROGRAM

(71) Applicant: KONICA MINOLTA, INC., Tokyo (JP)

(72) Inventor: Masayuki YASUKAGA, Tokyo (JP)

(73) Assignee: KONICA MINOLTA, INC., Tokyo (JP)

(21) Appl. No.: 15/873,210

(22) Filed: Jan. 17, 2018

(30) Foreign Application Priority Data
Feb. 23, 2017 (JP) 2017-032090

(51) Int. Cl. H04N 1/44; G06T 7/00; G06F 17/30

(52) U.S. Cl. CPC H04N 1/4486; G06T 2207/30168; G06F 17/30244; G06T 7/0008

(57) ABSTRACT

An image forming apparatus includes: an image former that forms an image on a sheet on a basis of image data for image formation; a reader that reads the image formed on the sheet to generate read image data; an inspector that compares the read image data with the image data for image formation and outputs an inspection result; an encryptor that encrypts data; a data storage that stores data; and a controller that controls image formation, reading, comparison, encryption, and storing, wherein the controller performs control such that, when at least one of the inspection result and the read image data is stored in the data storage as storing target data, a size of the storing target data is smaller in a case where the storing target data is encrypted than in a case where the storing target data is not encrypted.

The entire disclosure of Japanese patent Application No. 2017-032090, filed on Feb. 23, 2017, is incorporated herein by reference in its entirety.

### BACKGROUND

### Technological Field

The present invention relates to an image forming apparatus and an image formation control program, more particularly to a technique for appropriately handling storing target data by inspecting an image of a sheet on which an image is to be formed and which is to be output.

### Description of the Related art

There is an image forming apparatus in which a reader is connected to, at a subsequent stage, an image former that forms an image on a sheet and an image on the sheet on which the image has been formed is read by the reader.

Such an image forming apparatus is used for referring to a reading result after the image formation, adjusting an image forming position and the image quality, finding a sheet with defective image formation (detecting a defective image), storing an image formation result as an evidence (evidence confirmation image), and so forth.

As this type of technology, various related proposals have been made in JP 2016-206691 A.

JP 2016-206691 A discloses an image processing apparatus that compares first image data (image data for image formation) generated as data representing a reference image to be an inspection reference and second image data (read image data) generated as data representing an inspection image to be an inspection target, and thus automatically extracts difference between the first image data and the second image data.

Thus, as the image forming apparatus, there is a machine having an image inspection function (defect inspection function) for comparing the image data for image formation with the read image data. Further, in this image inspection processing, a large amount of storing target data (inspection result and read image data) is stored in a hard disk drive.

To be noted, in recent years, from the viewpoint of maintaining confidentiality of information, itis becoming common to store encrypted data in a hard disk drive.

Here, when the image formation in the image forming apparatus and the inspection of the image that has been formed are performed in parallel, sometimes a problem arises that, in the case where the above-described encryption setting is turned on and encrypted storing target data is stored in the hard disk drive, time required for inspection including encryption exceeds the time of image formation, it becomes necessary to delay the image formation, and thus the productivity is lowered.

Although JP 2016-206691 A includes a description of, for example, encrypting difference image data at the time of the image inspection processing, any disadvantage such as processing delay due to the encryption processing is not taken into consideration at all.

### SUMMARY

An object of the present invention is to provide an image forming apparatus and an image formation control program which do not lower the productivity of image formation even in the case of performing image inspection in parallel with image formation and encrypting storing target data.

To achieve the abovementioned object, according to an aspect of the present invention, an image forming apparatus reflecting one aspect of the present invention comprises: an image former that forms an image on a sheet on a basis of image data for image formation; a reader that reads the image formed on the sheet by the image former to generate read image data; an inspector that compares the read image data with the image data for image formation and outputs an inspection result; an encryptor that encrypts data; a data storage that stores data; and a controller that controls image formation performed by the image former, reading performed by the reader, comparison performed by the inspector, encryption performed by the encryptor, and storing performed by the data storage, wherein the controller performs control such that, when at least one of the inspection result and the read image data is stored in the data storage as storing target data, a size or the storing target data is smaller in a case where the storing target data is encrypted than in a case where the storing target data is not encrypted.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram illustrating a configuration of an embodiment of the present invention;

FIG. 2 is a configuration diagram illustrating a configuration of the embodiment of the present invention;

FIG. 3 is a configuration diagram illustrating a configuration of the embodiment of the present invention;

FIG. 4 is a configuration diagram illustrating a configuration of the embodiment of the present invention;

FIG. 5 is a flowchart illustrating an operation of the embodiment of the present invention;

FIG. 6 is an explanatory diagram illustrating the embodiment of the present invention;

FIG. 7 is a flowchart illustrating an operation of the embodiment of the present invention; and

FIG. 8 is an explanatory diagram illustrating the embodiment of the present invention.

### DETAILED DESCRIPTION OF EMBODIMENTS

Hereinafter, one or more embodiments in which an image of a sheet to be output after image formation in an image forming apparatus or an image forming system is efficiently read with a necessary image quality will be described in detail with reference to the drawings. However, the scope of the invention is not limited to the disclosed embodiments.

[Configuration]

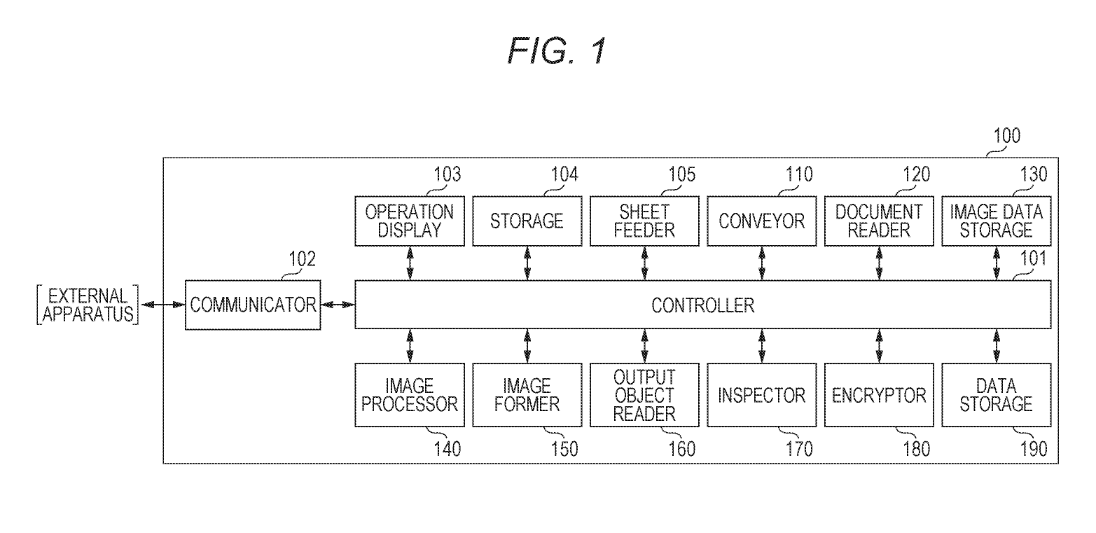

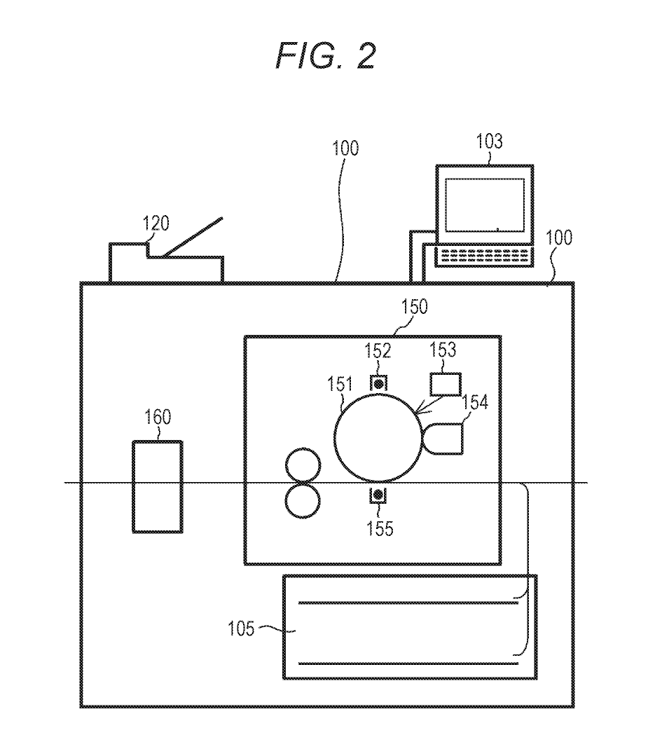

Here, a configuration example of an image loaning apparatus will be described in detail with reference to FIGS. 1 and 2. In FIGS. 1 and 2, an image forming apparatus 100 including an output object reader will be described.

Here, the image forming apparatus 100 includes a controller 101, a communicator 102, an operation display 103, a storage 104, a sheet feeder 105, a conveyor 110, a document reader 120, an image data storage 130, an image processor 140, an image former 150, an output object reader 160, an inspector 170, an encryptor 180, and a data storage 190. The controller 101 controls each component included in the image forming apparatus 100. The communicator 102 communicates with another apparatus connected thereto. The operation display 103 displays the state of the image forming apparatus, and a user inputs operations through the operation display 103. The storage 104 stores various settings. The sheet feeder 105 is capable of feeding a sheet housed in a sheet feeding tray. The conveyor 110 conveys the sheet in the image forming apparatus 100. The document reader 120 reads a document to generate read image data. The image data storage 130 stores image data for image formation and various data used in image formation. The image processor 140 performs various image processing necessary for image formation. The image former 150 forms an image on a sheet on the basis of an image formation command and the image data for image formation. The output object reader 160 reads an image (output object) formed on a sheet to generate read image data. The inspector 170 compares the image data for image formation with the read image data and thereby inspects the presence or absence of difference therebetween. The encryptor 180 encrypts data. The data storage 190 is constituted by, for example, a hard disc drive, and stores an inspection result.

Here, the encryptor 180 may be configured integrally with the data storage 190, or the encryptor 180 may be configured to be executed by the controller 101 in accordance with encryption software.

As illustrated in FIG. 2, the image former 150 includes an image carrier 151, a charger 152, an exposing unit 153, a developing unit 154, and a transfer unit 155. The image carrier 151 carries a toner image formed thereon. The charger 152 charges the image carrier 151 to a predetermined potential. The exposing unit 153 exposes the charged image carrier 151 in accordance with image data for image formation to form an electrostatic latent image. The developing unit 154 develops the electrostatic latent image into a toner image. The transfer unit 155 transfers the toner image onto a sheet. To be noted, the configuration of the image former 150 is merely an example, and a configuration that performs multi-color image formation using an intermediate transfer member may also he adopted. Further, the image former 150 may be configured to invert the sheet to form images on both surfaces of the sheet.

Here, the output object reader 160 is disposed downstream of the image former 150 in a sheet conveyance direction, and is configured to read an image of an output sheet during conveyance. To be noted, the output object reader 160 may read one surface of a sheet or may read both surfaces of a sheet at one time.

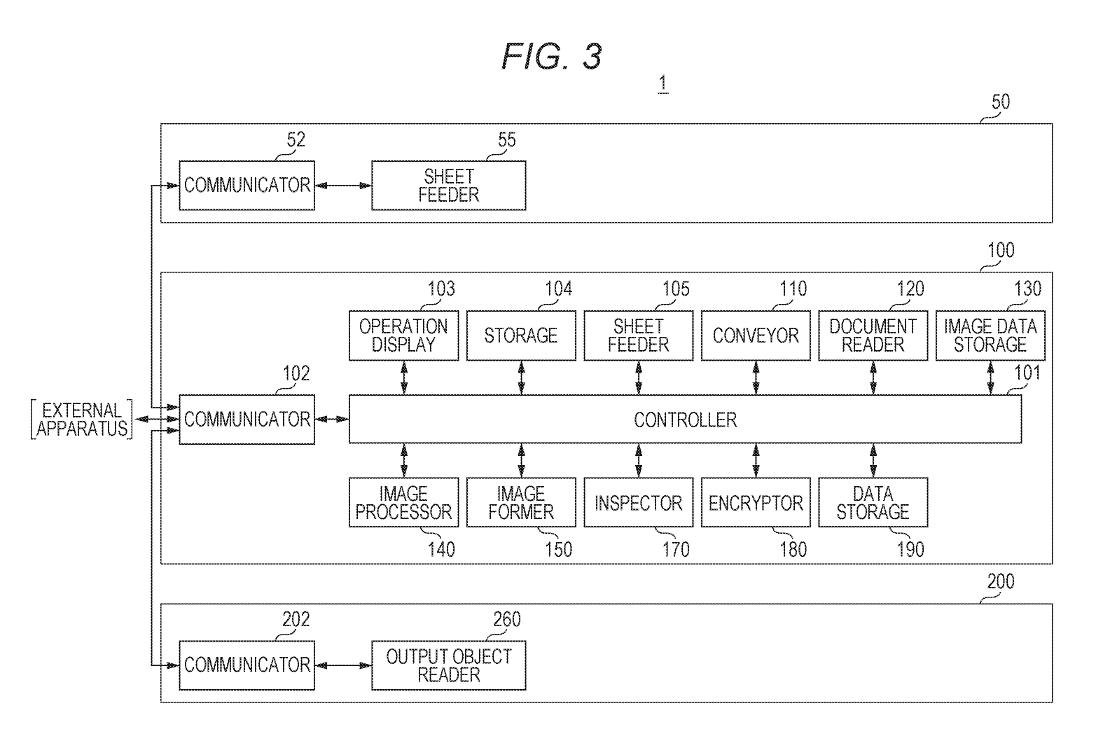

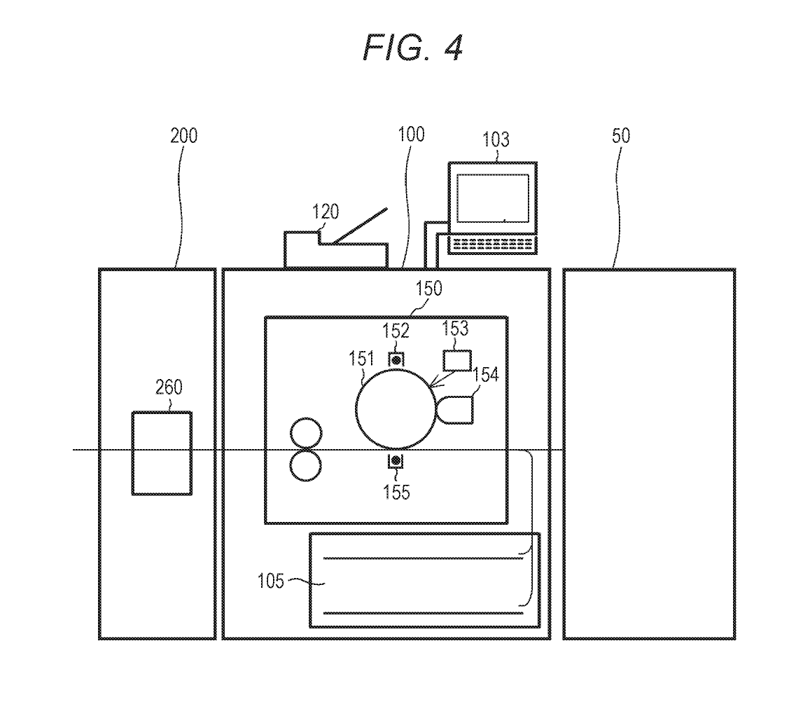

Here, a configuration example of an image forming system 1 will be described in detail with reference to FIGS. 3 and 4. With reference to FIGS. 3 and 4, the image forming system 1 including a sheet feeding apparatus 50, an image forming apparatus 100, and a reading apparatus 200 will be described.

Here, the image forming apparatus 100 is similar to that illustrated in FIGS. 1 and 2, and does not include an output reader. In addition, although the image forming apparatus 100 includes an output object reader, the image forming apparatus 100 may use an output object reader in the reading apparatus 200. In FIGS. 1 and 2 and FIGS. 3 and 4, the same numerals are given to the same elements, and redundant explanations are omitted.

Here, the reading apparatus 200 is disposed downstream of the image forming apparatus 100 in the sheet conveyance direction. The reading apparatus 200 is configured to include a communicator 202 and an output object reader 260 that reads an image formed on a sheet, so that an image of an output sheet is read during conveyance.

To be noted, a configuration in which the reading apparatus 200 is configured as a subsequent unit to the image forming apparatus 100 and the output object reader 260 is included in a post-processing apparatus including a post-processing unit that is not illustrated may be adopted.

To be noted, the output object reader 160 in FIGS. 1 and 2 and the output object reader 260 in FIGS. 3 and 4 are each configured to include an image pickup element of a line sensor type whose longitudinal direction is orthogonal to the sheet conveyance direction, and thus read an image of an output sheet during conveyance.

### FIRST OPERATION EXAMPLE

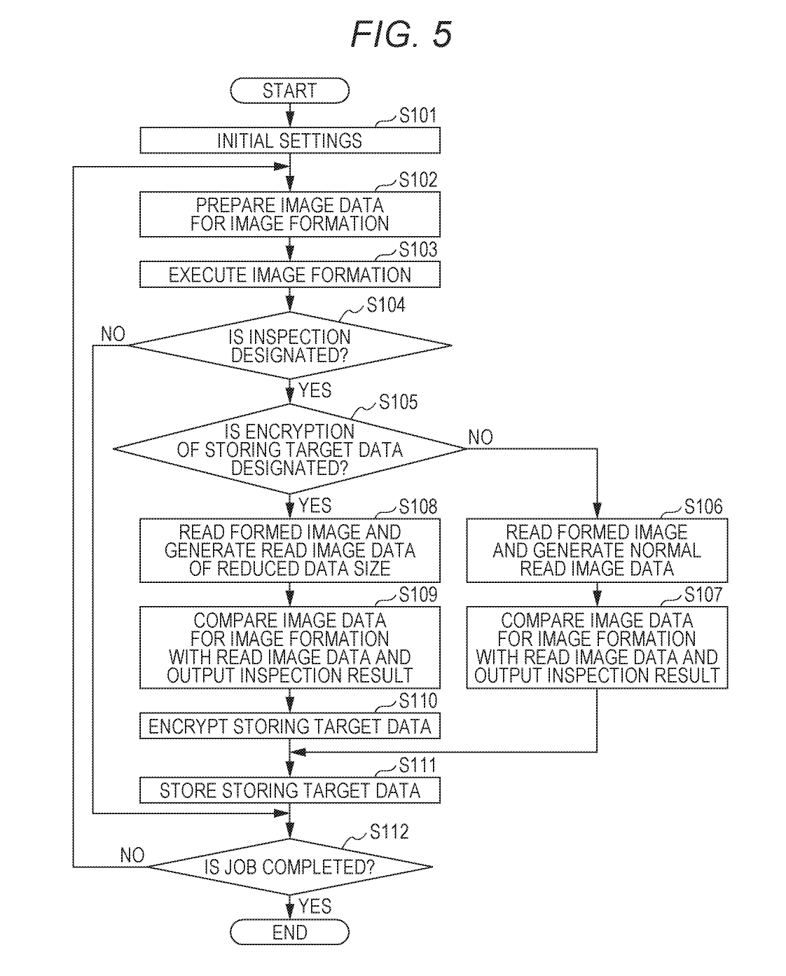

Hereinafter, a first operation example of the image forming apparatus 100 will be described with reference to a flowchart of FIG. 5. Here, although an operation of the image forming apparatus 100 including the output object reader 160 will be described as a specific example, the operation of the image forming system 1 is almost the same. In addition, the operations of the image forming apparatus 100 and the image forming system 1 are realized under control of the controller 101 in accordance with an image formation control program.

At the start of image formation, the controller 101 sets or initializes each component in the image forming apparatus 100 in accordance with an image formation mode of a job to be executed (step S101 of FIG. 5).

The controller 101 transfers image data for image formation of a page for which image formation is to be performed to a print preparation memory in the image data storage 130 (step S102 of FIG. 5). Then, in accordance with the timing of image formation, the controller 101 reads the image data for image formation from the print preparation memory and transfers the image data for image formation that has been read to the image former 150, thereby performing control such that an image based on the image data for image formation is performed by the image former 150 (step S103 in FIG. 5).

Here, if inspection by comparison between an original image (image data for image formation) and a printed image (read image data) is not designated (NO in step S104 of FIG. 5), the controller 101 controls each component such that preparation of image data for image formation (Step S102 of FIG. 5) and execution of image formation (step S103 of FIG. 5) are repeated until the last page of a designated job is reached (step S112 of FIG. 5).

In addition, if inspection by comparison between an original image (image data for image formation) and a printed image (read image data) is designated (YES in step S104 of FIG. 5) and storing of storing target data with encryption is not designated (NO in step S105 of FIG. 5), the controller 101 controls sheet conveyance by the conveyor 110 and reading by the output object reader 160 such that the output object reader 160 reads an image on the sheet having been subjected to image formation to generate read image data (step S106 of FIG. 5).

To be noted, in the first operation example, the storing target data is data including at least one of an inspection result and the read image data.

At this time, the controller 101 performs control such that the reading resolution of the output object reader 160 matches the output resolution of image formation by the image former 150. To be noted the controller 101 treats the reading resolution matching the output resolution as a normal reading resolution.

Further, the controller 101 controls the inspector 170 so as to perform inspection by comparing the read image data obtained by the output object reader 160 with the image data for image formation used in the image formation by the image former 150 (Step S107 of FIG. 5). Here, the inspection result (information on matching/no matching and information on a portion that does not match) of the comparison is output from the inspector 170.

Then, the controller 101 performs control such that the inspection result and read image data are stored in the data storage 190 as storing target data (step S111 of FIG. 5).

As described above, if inspection by comparison between an original image (image data for image formation) and a printed image (read image data) is designated and encryption is not designated (YES in step S104 of FIG. 5 and NO in step S105 of FIG. 5), the controller 101 controls each component such that preparation of the image data for image formation (step S102 of FIG. 5), execution of image formation (step S103 of FIG. 5), generation of the read image data (step S106 of FIG. 5), comparison inspection between the image data for image formation and the read image data (step S107 of FIG. 5), and storing of the inspection result and the read image data (step S111 of FIG. 5) are repeated until the last page of the designated job is reached (step S112 of FIG. 5).

In contrast, if inspection by comparison between an original image (image data for image formation) and a printed image (read image data) is designated (YES in step S104 of FIG. 5) and storing of storing target data with encryption is designated (YES in step S105 of FIG. 5), the controller 101 controls sheet conveyance by the conveyor 110 and reading by the output object reader 160 such that the output object reader 160 reads an image on the sheet having been subjected to image formation to generate read image data of a reduced data size (step S108 of FIG. 5). Here, the controller 101 performs control such that the reading resolution of the output object reader 160 is lower than the output resolution of image formation by the image former 150. That is, the controller 101 controls the reading resolution in the case where storing with encryption is designated to be, for example, ½ of the output resolution. More specifically, in the case where the image forming resolution is 600 dpi in the main scanning direction and 600 dpi in the sub scanning direction, the reading resolution is set to 300 dpi in the main scanning direction and 300 dpi in the sub scanning direction. To be note, the resolution in either the train scanning direction or the sub scanning direction may be lowered. In addition, regarding reduction of the resolution, the reading resolution may be ⅓ or ¼ of the output resolution instead of ½.

Here, the controller 101 controls the inspector 170 so as to perform inspection by comparing the read image data obtained by the output object reader 160 with the image data for image formation used in the image formation by the image former 150 (Step S109 of FIG. 5). To be noted, in the case where the reading resolution at the time of obtaining the read image data is lower than the image forming resolution, the resolution is lowered also for the image data for image formation which is the basis of the comparison such that comparison is performed in a state in which the resolution of the read image data matches the resolution of the image data for image formation.

Then, the controller 101 performs control such that the encryptor 180 encrypts the inspection result and the read image data of a reduced data size as storing target data (step S110 of FIG. 5), and the encrypted storing target data is stored in the data storage 190 (step S111 of FIG. 5).

As described above, if inspection by comparison between an original image (image data for image formation) and a printed image (read image data) and storing of the storing target data with encryption are designated (YES in step S104 of FIG. 5 and YES in step S105 of FIG. 5), the controller 101 controls each component such that preparation of the image data for image formation (step S102 of FIG. 5), execution of image formation (step S103 of FIG. 5), generation of the read image data of a reduced data size (step S108 of FIG. 5), comparison inspection between the image data for image formation and the read image data (step S109 of FIG. 5), encryption of the storing target data (the inspection result and the read image data) (step S110 of FIG. 5), and storing of the encrypted storing target data (step S111 of FIG. 5) are repeated until the last page of the designated job is reached (step S112 of FIG. 5).

As described above, when comparing the read image data with the image data for image formation and outputting the inspection result, control is performed such that the size of the storing target data is smaller in the case where the storing target data is encrypted than in the case Where the storing target data is not encrypted. As a result of this, even in the case where image inspection is performed in parallel with image formation and the storing target data is encrypted, time for inspection and encryption can be kept at a certain level or lower, and thus lowering the productivity of image formation can be prevented.

In addition, in the present embodiment, when image formation, comparison, encryption, and storing are performed in parallel, time required for comparison, encryption, and storage for one sheet on which an image has been formed does not exceed time for an image former to form an image on one sheet. As a result of this, even in the case where image inspection is performed in parallel with image formation and the storing target data is encrypted, time for inspection and encryption does not exceed time for image formation, and thus lowering the productivity of image formation can be prevented.

That is, even in the case where the storing target data is encrypted, the size of the storing target data is reduced, thus time for inspection and encryption becomes less likely to exceed time for image formation, and lowering the productivity of image formation can be prevented.

### MODIFICATION OF FIRST OPERATION EXAMPLE

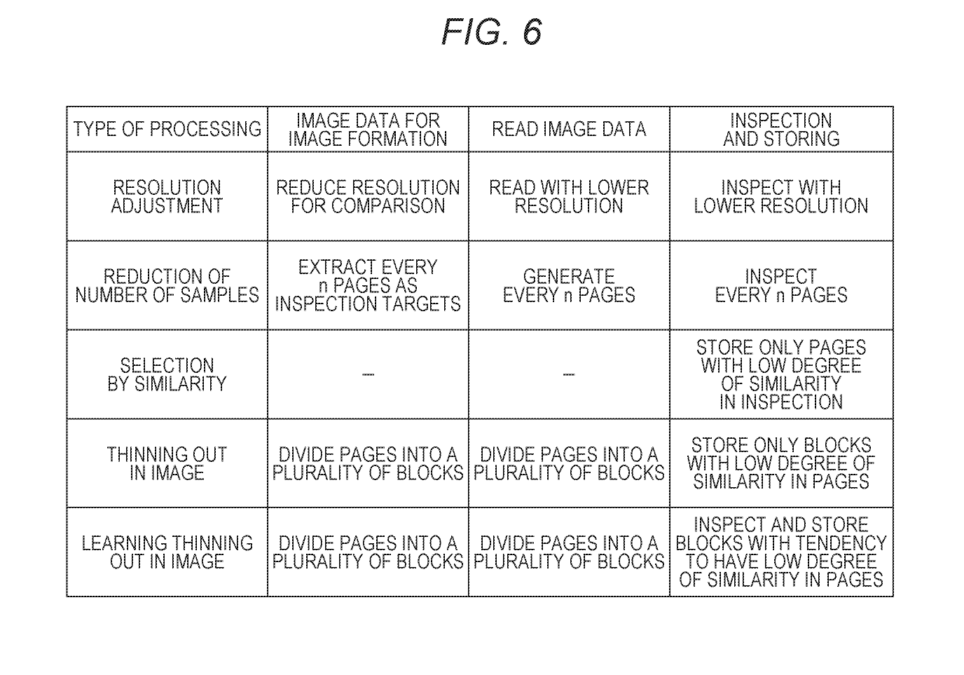

FIG. 6 is a table showing inspection examples and handling examples of the storing target data in the case where the storing target data is encrypted in the present embodiment. To be noted, the above description of the first operation example corresponds to the case of “resolution adjustment” in FIG. 6.

In addition, in the case Where encryption of the storing target data is designated, the inspection is performed for pages extracted every n pages instead of all the pages as “reduction of number of samples” of FIG. 6, the inspection result of the state in which the data is thinned out and the read image data are encrypted and stored as the storing target data, and thus it is possible to reduce the amount of data, shorten the processing time, and not lower the productivity of image formation.

In addition, in the case where encryption of the storing target data is designated, the inspection is performed for all the pages as “selection by similarity” of FIG. 6, the inspection result and the read image data of pages with low degree of similarity in the inspection are encrypted and stored as the storing target data, and thus it is possible to reduce the amount of data, shorten the processing time, and not lower the productivity of image formation.

In addition, in the case where encryption of the storing target data is designated, the inspection is performed for all the pages as “selection by similarity” of FIG. 6, the read image data of pages with low degree of similarity in the inspection and the inspection result are encrypted and stored as the storing target data, and thus it is possible to reduce the amount of data, shorten the processing time, and not lower the productivity of image formation.

In addition, in the case where encryption of the storing target data is designated, the inspection is performed for all the pages after dividing each page into a plurality of blocks as “thinning out in image” of FIG. 6, blocks with low degree of similarity of the inspection result and the read image data are encrypted and stored as the storing target data, and thus it is possible to reduce the amount of data, shorten the processing time, and not lower the productivity of image formation. In this case, the image data for image formation and the read image data are divided into blocks within each page and compared, and blocks having high similarity in the inspection are not included in the storing target data. Therefore, it is possible to appropriately reduce the size of the storing target data.

In addition, in the case where encryption of the storing target data is designated, the inspection is performed for all the pages after dividing each page into a plurality of blocks as “learning thinning out in image” of FIG. 6, blocks at positions with tendency to have low degree of similarity in the inspection of the inspection result and the read image data are encrypted and stored as the storing target data in accordance with the tendency of the inspection result in a certain period, and thus it is possible to reduce the amount of data, shorten the processing time, and not lower the productivity of image formation. In this case, the image data for image formation and the read image data are divided into blocks within each page and compared, and blocks with tendency to have high degree of similarity in the inspection are not included in the storing target data. Therefore, it is possible to appropriately reduce the size of the storing target data.

### SECOND OPERATION EXAMPLE

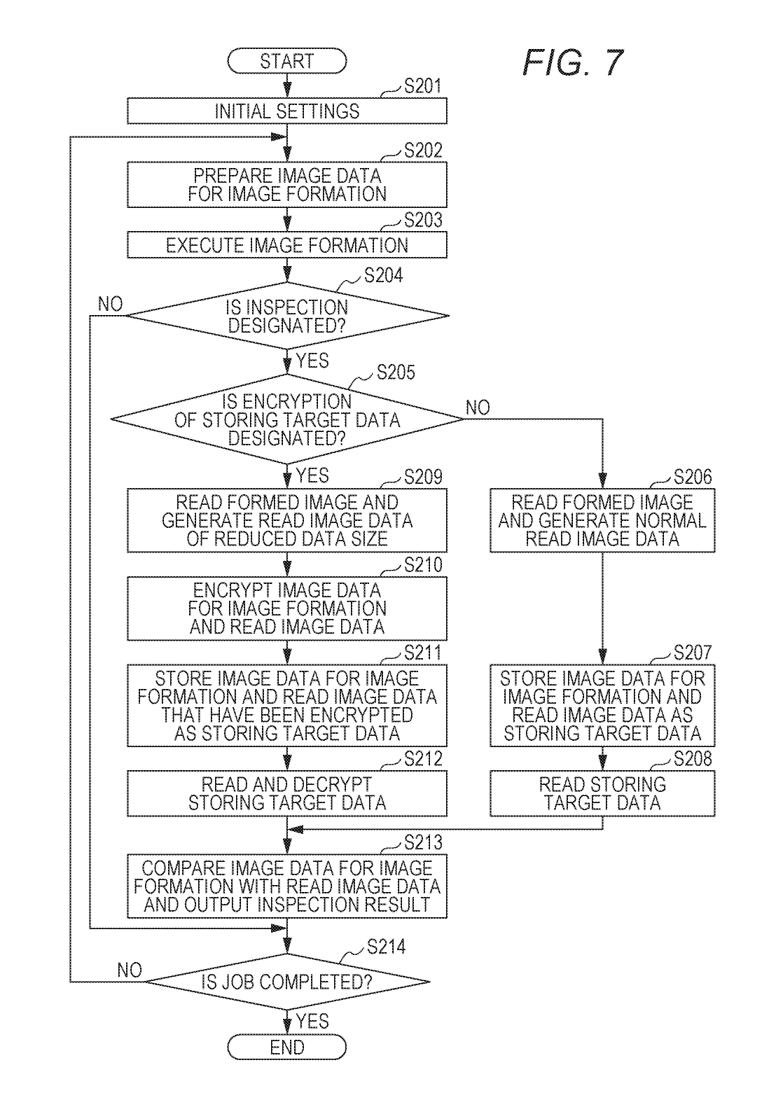

Hereinafter, a second operation example of the image forming apparatus 100 will be described with reference to a flowchart of FIG. 7. Here, although an operation of the image forming apparatus 100 including the output object reader 160 will be described as a specific example, the operation of the image forming system 1 is almost the same. In addition, the operations of the image forming apparatus 100 and the image forming system 1 are realized under control of the controller 101 in accordance with an image formation control program. To be noted, in the second operation example, it is assumed that the encryptor 180 can also perform decryption.

At the start of image formation, the controller 101 sets or initializes each component in the image forming apparatus 100 in accordance with an image formation mode of a job to be executed (step S201 of FIG. 7).

The controller 101 transfers image data for image formation of a page for which image formation is to be performed to a print preparation memory in the image data storage 130 (step S202 of FIG. 7), Then, in accordance with the timing of image formation, the controller 101 reads the image data for image formation from the print preparation memory and transfers the image data for image formation that has been read to the image former 150, thereby performing control such that an image based on the image data for image formation is performed by the image former 150 (step S203 of FIG. 7).

Here, if inspection by comparison between an original image (image data for image formation) and a printed image (read image data) is not designated (NO in step S204 of FIG. 7), the controller 101 controls each component such that preparation of image data for image formation (Step S202 of FIG. 7) and execution of image formation (step S203 of FIG. 7) are repeated until the last page of a designated job is reached (step S214 of FIG. 7).

In addition, if inspection by comparison between an original image (image data for image formation) and a printed image (read image data) is designated (YES in step S204 of FIG. 7) and storing of storing target data with encryption is not designated (NO in step S205 of FIG. 7), the controller 101 controls sheet conveyance by the conveyor 110 and reading by the output object reader 160 such that the output object reader 160 reads an image on the sheet having been subjected to image formation to generate read image data (step S206 of FIG. 7).

To be noted, in the second operation example, both of the image data for image formation and the read image data are the storing target data.

At this time, the controller 101 performs control such that the reading resolution of the output object reader 160 matches the output resolution of image formation by the image former 150. To be noted the controller 101 treats the reading resolution matching the output resolution as a normal reading resolution.

Here, the controller 101 performs control such that the read image data obtained by the output object reader 160 and the image data for image formation used in the image formation by the image former 150 are stored in the data storage 190 as the storing target data (Step S207 of FIG. 7).

Then, the controller 101 reads the image data for image formation and the read image data that have been stored from the data storage 190 (step S208 of FIG. 7), and controls the inspector 170 so as to perform inspection by comparing these data with each other (step S213 of FIG. 7). Here, the inspection result (information on matching/no matching and information on a portion that does not match) of the comparison is output from the inspector 170.

As described above, if inspection by comparison between the image data for image formation and the read image data is designated and encryption is not designated (YES in step S204 of FIG. 7 and NO in step S205 of FIG. 7), the controller 101 controls each component such that preparation of the image data for image formation (step S202 of FIG. 7), execution of image formation (step S203 of FIG. 7), generation of the read image data (step S206 of FIG. 7), storing of the image data for image formation and the read image data as the storing target data (step S207 of FIG. 7), reading of the storing target data (step S208 of FIG. 7), and comparison inspection between the image data for image formation and the read image data (step S213 of FIG. 7) are repeated until the last page of the designated job is reached (step S214 of FIG. 7).

In contrast, if inspection by comparison between an original image (image data for image formation) and a printed image (read image data) is designated (YES in step S204 of FIG. 7) and storing of the storing target data with encryption is designated (YES in step S205 of FIG. 7), the controller 101 controls sheet conveyance by the conveyor 110 and reading by the output object reader 160 such that the output object reader 160 reads an image on the sheet having been subjected to image formation to generate read image data of a reduced data size (step S209 of FIG. 7). Here, the controller 101 performs control such that the reading resolution of the output object reader 160 is lower than the output resolution of image formation by the image former 150. That is, the controller 101 controls the reading resolution in the case where storing with encryption is designated to be, for example, ½ oldie output resolution. More specifically, in the case where the image forming resolution is 600 dpi in the main scanning direction and 600 dpi in the sub scanning direction, the reading resolution is set to 300 dpi in the main scanning direction and 300 dpi in the sub scanning direction. To be note, the resolution in either the main scanning direction or the sub scanning direction may be lowered. In addition, regarding reduction of the resolution, the reading resolution may be ⅓ or ¼ of the output resolution instead of ½.

In addition, the controller 101 performs resolution conversion of the image data for image formation so that the resolution thereof becomes as low as the resolution of the read image data, performs control such that the read image data of a low resolution and the image data for image formation converted to have a low resolution are encrypted by the encryptor 180 as the storing target data (step S210 of FIG. 7), and performs control such that the encrypted storing target data is stored in the data storage 190 (step S211 of FIG. 7).

Then, the controller 101 reads the image data for image formation and the read image data that have been encrypted and stored as the storing target data from the data storage 190 and decrypt these data (step S212 of FIG. 7), and controls the inspector 170 so as to perform inspection by comparing these data with each other (step S213 of FIG. 7). Here, the inspection result (information on matching/no matching and information on a portion that does not match) of the comparison is output from the inspector 170.

As described above, if inspection by comparison between an original image (image data for image formation) and a printed image (read image data) and storing of the storing target data with encryption are designated (YES in step S204 of FIG. 7 and YES in step S205 of FIG. 7), the controller 101 controls each component such that preparation of the image data for image formation (step S202 of FIG. 7), execution of image formation (step S203 of FIG. 7), generation of the read image data of a reduced data size (step S209 of FIG. 7), encryption of the storing target data (step S210 of FIG. 7), storing of the encrypted storing target data (step S211 of FIG. 7), reading and decryption of the encrypted storing target data (step S212 of FIG. 7), and comparison inspection of the image data for image formation and the read image data (step S213 of FIG. 7) are repeated until the last page of the designated job is reached (step S214 of FIG. 7).

As described above, when storing and comparing the read image data of a reduced data size with the image data for image formation as the storing target data and outputting the inspection result, control is performed such that the size of the storing target data is smaller in the case where the storing target data is encrypted than in the case where the storing target data is not encrypted. As a result of this, even in the case where storing target data is encrypted in parallel with image formation, time for encryption can be kept at a certain level or tower, and thus lowering the productivity of image formation can be prevented. That is, even in the case Where the storing target data is encrypted and stored, the size of the storing target data is reduced, thus time for encryption and storing becomes less likely to exceed time for image formation, and lowering the productivity of image formation can be prevented.

### MODIFICATION OF SECOND OPERATION EXAMPLE

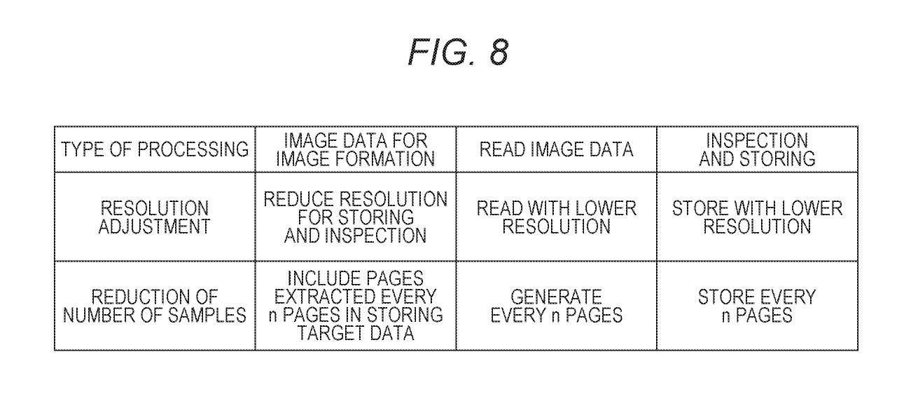

FIG. 8 is a table showing inspection examples and handling examples of the storing target data in the case where the storing target data is encrypted in the present embodiment. To be noted, the above description of the second operation example corresponds to the case of “resolution adjustment” in FIG. 8.

In addition, in the case where encryption of the storing target data is designated, storing target data in a state in Which pages are extracted every n pages instead of all the pages is encrypted, stored, decrypted, and then inspected as “reduction of number of samples” of FIG. 8, and thus it is possible to reduce the amount of data, shorten the processing time, and not lower the productivity of image formation.

### OTHER EMBODIMENT 1

Although an example in which the storing target data is stored in the data storage 190 has been described in the above embodiment, a configuration in which the storing target data is stored in an external server connected via a network or a storage device such as a network attached storage (NAS) may be adopted.

### OTHER EMBODIMENT 2

Although a specific example in which all or a part of the read image data and all or a part of the image data for image formation are stored in a storage as the storing target data has been described in the above embodiment, the configuration is not limited to this.

As the storing target data, any of only the inspection result, only the read image data, the inspection result and the read image data, the image data for image formation and the read image data, the inspection result and the image data for image formation and the read image data, all or a part of these, and so forth may be adopted.

In addition, if there is more time than time required for storing the data encrypted by the above embodiment, image data for image formation corresponding to the read image data is preferably stored in addition to the read image data.

### OTHER EMBODIMENT 3

In addition, the specific numerical values (600 dpi of the normal reading resolution, 300 dpi of the reading resolution at the time of encryption, and so forth) used in the above embodiment are mere examples and can be replaced with appropriate other numerical values.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms an image on a sheet on a basis of image data for image formation;
a reader that reads the image formed on the sheet by the image former to generate read image data;
an inspector that compares the read image data with the image data for image formation and outputs an inspection result;
an encryptor that encrypts data;
a data storage that stores data; and
a controller that controls image formation performed by the image former, reading performed by the reader, comparison performed by the inspector, encryption performed by the encryptor, and storing performed by the data storage,
wherein the controller performs control such that, when at least one of the inspection result and the read image data is stored in the data storage as storing target data, a size of the storing target data is smaller in a case where the storing target data is encrypted than in a case where the storing target data is not encrypted.

2. The image forming apparatus according to claim 1, wherein, when image formation by the image former and storing of the storing target data in the data storage are performed in parallel, the controller performs control such that time required for comparison, encryption, and storing for one sheet on which an image has been formed is not longer than time required for the image former to form an image on one sheet.

3. The image forming apparatus according to claim 1, wherein, when image formation by the image former and storing of the storing target data in the data storage are performed in parallel, the controller performs control such that the reader generates read image data less frequently in the case where the storing target data is encrypted than in the case where the storing target data is not encrypted.

4. The image forming apparatus according to claim 1, wherein the controller performs control such that the reader generates read image data of a lower resolution in the case where the storing target data is encrypted than in the case where the storing target data is not encrypted.

5. The image forming apparatus according to claim 1, wherein the controller performs control such that storing target data whose degree of matching or similarity in the comparison is equal to or lower than a threshold value is stored.

6. The image forming apparatus according to claim 1, wherein the inspector divides the read image data and the image data for image formation each into a plurality of blocks and compares the plurality of block with one another, and the storing target data includes a block whose degree of matching or similarity in the comparison is equal to or lower than a threshold value.

7. The image forming apparatus according to claim 1, wherein the inspector divides the read image data and the image data for image formation each into a plurality of blocks and compares the plurality of block with one another, and the controller performs control such that the storing target data includes only a block or blocks whose degree of matching or similarity in comparison in a certain period in past is equal to or lower than a threshold value.

8. The image forming apparatus according to claim 1, wherein, when performing control such that the image data for image formation and the read image data are stored in the data storage as the storing target data, the storing target data is read out from the data storage, and the inspector inspects the image data for image formation and the read image data, the controller performs control such that a size of the storing target data is smaller in a case where the storing target data is encrypted and stored than in a case where the storing target data is stored without being encrypted.

9. The image forming apparatus according to claim 8, wherein, when image formation by the image former and storing of the storing target data in the data storage are performed in parallel, the controller performs control such that the storing target data is generated less frequently in the case where the storing target data is encrypted than in the case where the storing target data is not encrypted.

10. The image forming apparatus according to claim 8, wherein the controller performs control such that the storing target data is generated from image data for image formation of a lower resolution and read image data of a lower resolution in the case where the storing target data is encrypted than in the case where the storing target data is not encrypted.
